(19) United States
(12) Patent Application Publication
(10) Pub. No.: US 2010/0087155 A1
(43) Pub. Date: Apr. 8, 2010

(54) ON-PREMISES RESTAURANT COMMUNICATION SYSTEM FOR COLLECTING FEEDBACK

(75) Inventor: Philippe S. Dubost, Vence (FR)

Correspondence Address: Philippe S. Dubost, 181 Boulevard Jean Maurel superieur, Vence, 06140, FR

(73) Assignee: Philippe Sebastien Dubost, Vence (FR)

(21) Appl. No.: 12/573,797

(22) Filed: Oct. 5, 2009

Related U.S. Application Data
(60) Provisional application No. 61/102,869, filed on Oct. 6, 2008.

(51) Int. Cl. H04B 1/38; G06F 3/02; G06Q 10/00; G06Q 50/00; G06F 3/01; G06F 17/30

(52) U.S. Cl. 455/90.1; 345/168; 705/347; 705/10; 715/760; 707/610; 707/E17.005

(57) ABSTRACT

An on-premises restaurant communication system for collecting feedback from the customers at the end of their meal.

At the end of a meal at the restaurant, the bill to pay (usually called “the check”) is brought inside a small dish, presenting a small screen and 3 buttons.

The customer reads the simple question about his experience that is displayed on the screen and answers by pushing one of the three keys on the apparatus.

In response to getting the answer, the client communication device transmits it to the on-premises central transmitter wirelessly.

Regularly, the on-premises central transmitter synchronizes with a remote global database over the internet to collect and store all settings and data. This information is then processed so as to generate statistics and make them available to the management of the restaurant over time.

### CROSS-REFERENCE TO RELATED APPLICATIONS

Provisional application No. 61102869 titled “Electronic Feedback Collection System for Restaurants”, filed on Oct. 6, 2008.

### BACKGROUND OF THE INVENTION

This invention relates to on-premises feedback collection systems. More particularly, and not by way of limitation, the present invention is directed to an on-premises restaurant feedback system and method that utilizes communication devices within a restaurant, each communication device having a simple screen that displays a question related to the meal experience and a simple data input device through which a customer may input their answer.

Nowadays, a small share of the restaurants and eateries are collecting the feedback of their patrons at the end of their meals.

Some restaurant chains, mostly fast-food restaurants, display on the customer's receipt an invitation to give feedback. An internet address (URL) is provided, usually along with a toll-free number. The customer is the told he should contact either means, provide some identification number printed on the receipt and answer a few questions. The incentive to give feedback is that the survey respondent may win a prize, some respondents being randomly picked.

This is, however, rarely done in more traditional “eat then pay” restaurants.

In other restaurants, a small paper form is handed with the check at the end of the meal, where customers are invited to write their comments. Although this method is simple, it presents significant drawbacks: first, having customers fill these small forms implies having someone collect them and aggregate all the data at some time.

In a few other restaurants, some sort of guest book is available by the entrance of the restaurant, so guests can leave their impressions when leaving. However, few patrons will take the time to do so on their way out. Besides, mostly people with extreme feelings (very unhappy or very pleased) will express themselves there.

The present invention provides a system that make feedback collection from the clients of restaurant east to take and easy to exploit.

### BRIEF SUMMARY OF THE INVENTION

A purpose of the invention is to provide restaurant managers with feedback from their customers, in order to help them take better decision day after day and optimize their business over time.

One advantage of the invention is its simplicity and quickness for the customer. The customer is given one question, and has to push one of the three keys of the electronic device to answer it, typically “Bad”, “Neutral” and “Good”.

Another advantage of the invention is that it is very easy for the management of the restaurant to exploit the information received. The customer feedback is all digital and stored in a database. An access to the web-based user interface using a simple web browser will then give clear information and intelligence to the management of the restaurant. From the same web-based user interface, they will be able to adjust settings, which will be transmitted to their in-premises system at the next synchronization.

The invention is a system for getting the customer input, transmit it to a central transmitter, and then upload it through internet to a remote central database.

The apparatus comprises a set of at least one client device (or client transmitter), and one central transmitter. The client transmitter(s) and the central transmitter are communicating wirelessly.

The central transmitter is a fixed device that will be located within the premises of a restaurant. It communicates with all client transmitters of that restaurant. It is AC-powered and connected to internet through a standard pre-existing internet access on the premises (either via Ethernet or wirelessly).

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### BRIEF DESCRIPTION OF THE SEVERAL VIEWS OF THE DRAWINGS

The features of the invention will be better understood by reference to the accompanying drawings which illustrate presently preferred embodiments of the invention. In the drawings:

FIG. 1 is a perspective view of a first embodiment of a client transmitter of the present invention.

FIG. 2 is a simplified block diagram of a first embodiment of the on-premises system of the present invention.

FIG. 3 is a flow chart of an exemplary process performed by the client/server system when collecting and processing a feedback from a restaurant customer.

FIG. 4 is a flow chart of the full process performed by the system when collecting and processing a feedback from a restaurant customer.

### DETAILED DESCRIPTION OF THE INVENTION

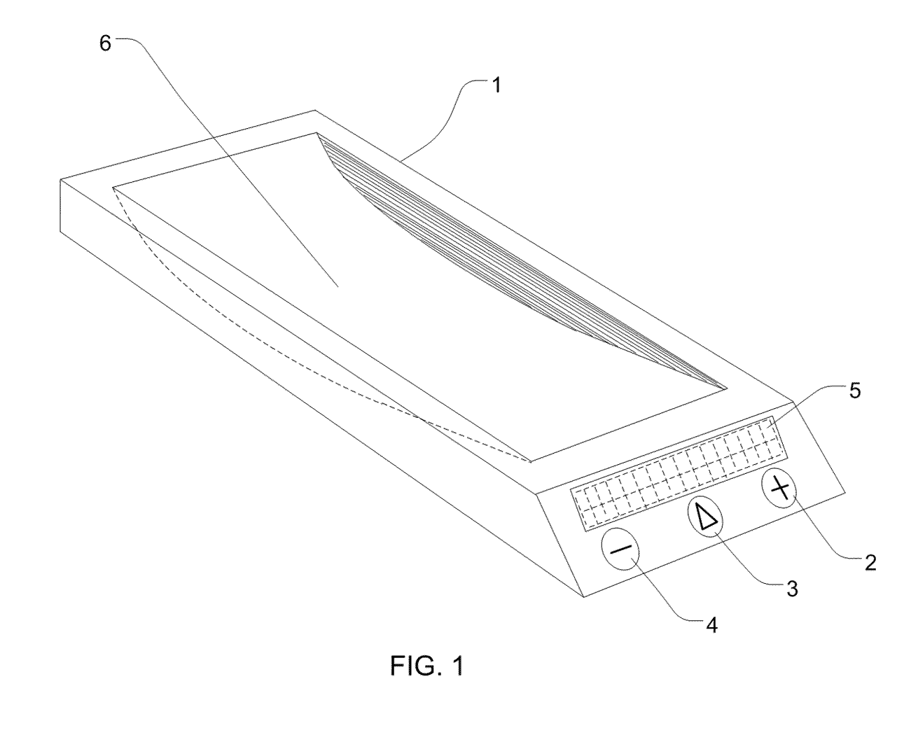

FIG. 1 is a perspective view of a first embodiment of a client transmitter of the present invention.

The device 1 appears very much like a classic small plastic dish commonly used to carry the check to the customer at the end of their meal. It will actually be used to carry the check, in its central concave area 6. Its main attributes is that it includes an electronic module composed of a processor, a wireless communication module, a display screen 5 and three keys 2, 3, 4. It is battery operated.
The display screen 5 is an LCD with a backlight. It is used to display the feedback question that the customer will be invited to answer.
When activated, using a combination of the three keys, the device 1 will randomly display one question from the set it was instructed. The restaurant customer then has a limited time to answer this question, using the “Positive” key 2, the “Neutral” key 3, or the “Negative” key 4. A sample question could be “How was your service today?” The customer could then push the “Positive” key 2 if he is satisfied. The device acknowledges the answer, transmits it to the central transmitter, and turns off to save power.
If the customer does not answer the question within the limited time (assuming he/she does not want to participate to this survey), the device turns off and will have to be reactivated to display a question and be able to accept and answer. This process is in order to save power, and also to prevent someone else to answer the question if the customer does not do it.

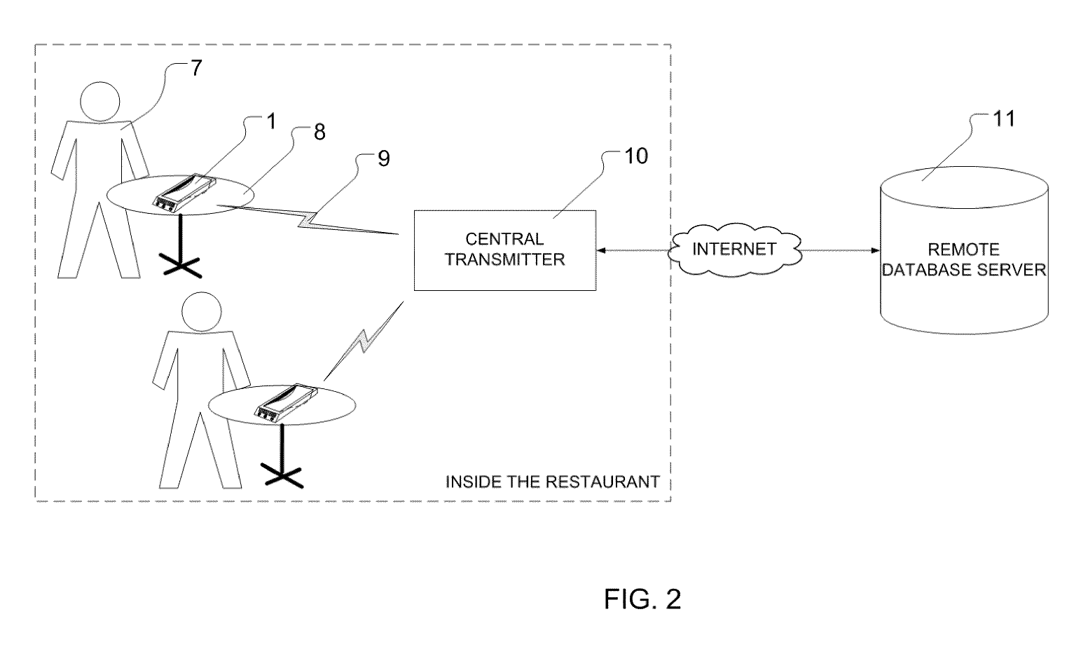

FIG. 2 is a simplified block diagram of a first embodiment of the on-premises system of the present invention. The present invention is an on-premises communication system that uses check-holder-shaped client devices and a central transmitter to collect the feedback of restaurant customers and transmit it to a central remote database.

In restaurants using this invention, the customer 7 is brought the check to their table 8 at the end of the meal. The check is carried inside the client transmitter device 1, which has the shape of a classic plastic dish commonly used to carry the check.
The client device 1 displays a question, that the customer is invited to answer using the keys on the device (cf. FIG. 1). Upon answering, the client device transmits the answer wirelessly to the central transmitter 10. This device comprises a processor, a storage space, a wireless communication module to communicate with the client devices, and an internet connection module used to connect to the Internet and synchronize with the central remote database 11. It stores the data received from the client devices, until it successfully synchronizes over the Internet with the remote database server 11. Upon synchronization, the data stored in the central transmitter 10 is uploaded to the remote database server 11, and settings are retrieved down to the central transmitter 10.

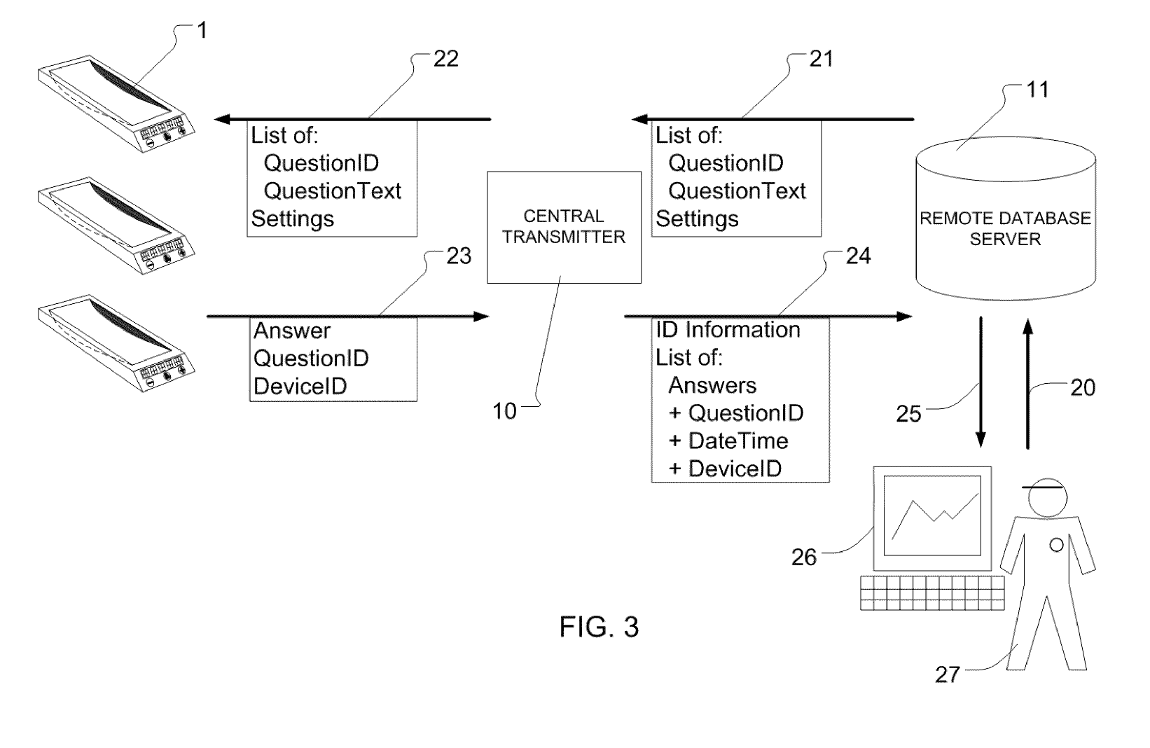

FIG. 3 is a flow chart of an exemplary process performed by the client/server system when collecting and processing a feedback from a restaurant customer.

The operator 27, typically the manager of the restaurant, connects to his remote database 11 using the web-based user interface of the system through a web browser 26. From there, he can adjust some settings related to his use of the system (the invention), for example the questions of the system, or the timeout of the client device. These settings are saved in the remote database server 11 during action 20. Upon synchronization of the local central transmitter 10 of his restaurant, a batch of data 21 is downloaded. This data 21 is composed of a set of settings, and a list of questions, that will be used by this restaurant. When the central transmitter 10 of the restaurant receives this information, it now needs to transmit this information to each individual client device 1. The information 22 transmitted to all individual devices 1 are some settings, and a list of questions (that will be randomly picked, as stated previously).
After the client enters their input on the client device 1, a set of information 23 is immediately sent to the central transmitter 10, containing the question asked, the answer picked, and the ID of the device. Then at the time of the next synchronization, the central transmitter 10, which has gathered the information from all client devices 1 since the previous synchronization, sends a batch of information 24 to the remote database server 11. This batch of information contains some identification information, and the list of all questions asked, answers received, and respective client device ID numbers. All of this is stored and processed in the remote database server 11.
Then, anytime the manager of the restaurant 27 needs to consult the statistics provided by this system (the invention), they access the web-based user interface 26, downloads the information 25 from the server, and gets the statistics related to their restaurant.

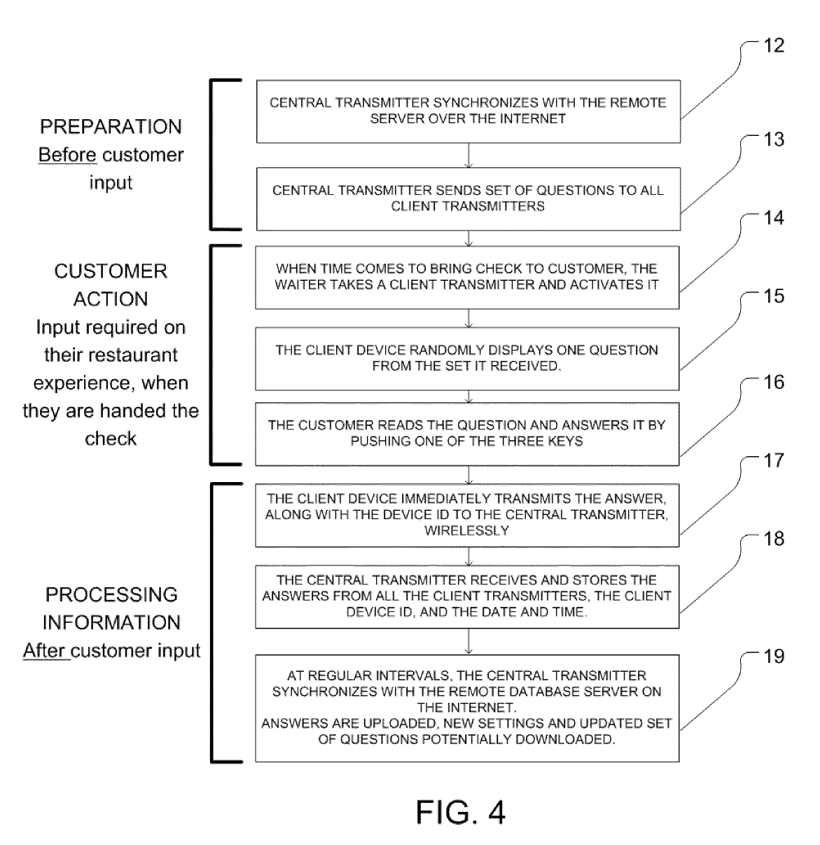

FIG. 4 is a flow chart of the full process performed by the system when collecting and processing a feedback from a restaurant customer.

The full process is divided in 3 main times: before getting the customer input, actually collecting the feedback, and processing the collected data.
Before first use, the central transmitter needs to be synchronized to the main remote database through internet. (12) All the settings and questions are then downloaded to the central transmitter, on the restaurant premises.
Then, the central transmitter remotely connects with all the client devices of the system and sends them the questions and some settings. (13)
The client device is now ready to be handed to a patron to collect their feedback.
When the time comes to bring the check to a customer, the operator turns on the device, by hitting a combination of keys for instance. (14).
The client device picks a question from its internal memory and displays it. (15). The customer reads the question on the screen and gives their opinion using one of the three keys on the device. (16). Now begin post-collection operations. The client device immediately sends the collected data (the answer to the one-question survey) to the central transmitter (17), the screen turns off. The central transmitter is actually collecting all the data from all client devices being operated within the restaurant premises. (18)
Periodically, the central transmitter synchronizes with the remote database server through the internet. All collected data since last synchronization are sent and will be stored. The aggregated data will then be processed on that server for consultation by the restaurant manager using their web-based interface.

Full operation of the invention involves having an Internet connection available on the premises of the restaurant. When an internet connection is not immediately available, the central transmitter 10 stores the collected information and retries to transmit it to the remote global database a few minutes later.

Many variations of the invention will occur to those skilled in the art. Some variations include the design of the client device. Other variations call for the technical features of either the client device of the central transmitter. All such variations are intended to be within the scope and spirit of the invention.

Although some embodiments are shown to include certain features, the applicant specifically contemplates that any feature disclosed herein may be used together or in combination with any other feature on any embodiment of the invention. It is also contemplated that any feature may be specifically excluded from any embodiment of an invention.

What is claimed is:

1. An on-premises restaurant communication system for collecting client feedback, said system comprising:
data displaying means on a client device given to the restaurant patron at the time they receive the check for displaying them a question asked about their experience.
data input means on the client device for the patron to input their answer to the question asked.
a communication transmitter receiver in the client device that receives questions and settings, and then sends the feedback collected back to the central transmitter.
a communication transmitter receiver in the central transmitter that transmits questions and settings to the client devices, and receives answers to the questions.
data memory in the central transmitter that stores the settings received from the remote database, and the feedback pending synchronization to that database.
an internet transmitter receiver in the central transmitter that retrieves periodically questions and settings from the remote database and sends back the feedback collected.
a user interface under the form of a web interface accessible from a standard web browser over the internet that enables the restaurant management to both program their devices and get information about the feedback collected.

2. The on-premises restaurant communication system for collecting client feedback of claim 1 wherein the client device is handed to the patron at the end of their meal as they receive the bill to pay.

3. The on-premises restaurant communication system for collecting client feedback of claim 1 wherein the client device used to collect the patron's feedback has a small multi-line back-lighted LCD screen to display the question asked to the customer and three buttons used to input answer to the question displayed.

4. The on-premises restaurant communication system for collecting client feedback of claim 1 wherein the client device used to collect the patron's feedback includes a radio frequency receiver and transmitter that sends and receives data from and to the central transmitter device.

5. The on-premises restaurant communication system for collecting client feedback of claim 1 wherein the central transmitter device includes a radio frequency receiver and transmitter that sends and receives data from and to client devices, and an internet connection mean to send and receive data from and to a remote database over the internet.

6. The client device of claim 3 wherein the three buttons used to provide input represent respectively a negative experience, a neutral experience, and a positive experience.

7. A method of collecting feedback from customers within a restaurant having a plurality of tables, said method comprising the steps of:
programming what questions to ask the customers through a web-based GUI (graphic user interface)
having the central transmitter synchronize with the remote database and the client devices within the restaurant.
bringing the bill to the customers in one of the dish-shaped client device
having the customers read the question on the client device and press a button to answer it.
having the client device then transmit the answer wirelessly to the central transmitter which will, in turn, transmit all the feedback received since its last transmission to the remote database.
getting data and statistics on the web-based GUI based on all the feedback aggregated overtime.
